(19) United States
(12) Patent Application Publication
(10) Pub. No.: US 2012/0072861 A1
(43) Pub. Date: Mar. 22, 2012

(54) METHOD AND APPARATUS FOR USER INTERACTION

(76) Inventors: Apaar Tuli, Helsinki (FI); Antonio Guadagno, Espoo (FI)

(21) Appl. No.: 13/375,152

(22) PCT Filed: Jun. 12, 2009
(86) PCT No.: PCT/FI09/50515

§ 371 Date: Nov. 29, 2011

(51) Int. Cl. G06F 3/048

(52) U.S. Cl. 715/767

(57) ABSTRACT

In accordance with an example embodiment of the present invention, an apparatus, a computer program product and a method is provided for detecting via a user interface that a user interface element requiring user input is active (510), receiving via a short-range communications interface at least identification information relating to one or more data items (520), accessing the one or more data items (530) and checking whether any of the one or more data items is suitable for inputting into the user interface element (540).

### TECHNICAL FIELD

The present application relates generally to user interaction in electronic devices.

### BACKGROUND

Modern society has adopted, and is becoming reliant upon, electronic devices for various purposes. Electronic devices can vary from battery powered handheld devices to stationary household and/or commercial devices utilizing an electrical network as a power source. An electronic device typically has a user interface that allows a user to interact with the electronic device in various ways, such as, for example to configure and/or control operation of the electronic device according to the user's liking and/or preferences.

Wireless interfaces provide transfer of information over a distance without the use of electrical conductors such as wires. The distances involved may range from a very short (in the range of centimeters or the like) to long (in the range of tens or hundreds of kilometers or even more). Electronic devices equipped with one or more wireless interface can interact with each other over a suitable communications protocol using the wireless interface. Alternatively, or in addition, electronic devices may be equipped with wired interface to interact with each other using wires.

### SUMMARY

Various aspects of examples of the invention are set out in the claims.

According to a first aspect of the present invention, a method is provided comprising detecting via a user interface that a user interface element requiring user input is active. The method further comprises receiving via a short-range communications interface at least identification information relating to one or more data items, accessing the one or more data items and determining whether any of the one or more data items is suitable for inputting into the active user interface element.

According to a second aspect of the present invention, a computer program product is disclosed, adapted to perform the above method when said program is run on a computer.

According to a third aspect of the present invention, an apparatus is disclosed, comprising a user interface configured to detect activation of a user interface element requiring user input, a short-range communications interface configured to receive at least identification information relating to one or more data items, and a processor, wherein the procressor is configured to access the one or more data items and to determine whether any of the one or more data items is suitable for inputting into the user interface element.

### BRIEF DESCRIPTION OF THE DRAWINGS

For a more complete understanding of example embodiments of the present invention, reference is now made to the following descriptions taken in connection with the accompanying drawings in which:

FIG. 1 discloses an example of an operational environment in which an apparatus according to an example embodiment of the invention may be used;

FIG. 2 discloses a modular layout for an apparatus according to an example embodiment of the present invention;

FIG. 3 discloses a user interface including several user interface elements according to an example embodiment of the present invention;

FIG. 4A discloses contents of a database according to an example embodiment of the present invention;

FIG. 4B discloses contents of a data item of the database of FIG. 4A according to an example embodiment of the present invention;

FIG. 5 illustrates a flow diagram showing operations for user interaction according to an example embodiment of the present invention; and

FIG. 6 discloses an apparatus comprising example hardware for implementing computer software instructions stored in the apparatus according to an example embodiment of the present invention.

### DETAILED DESCRIPTION OF THE DRAWINGS

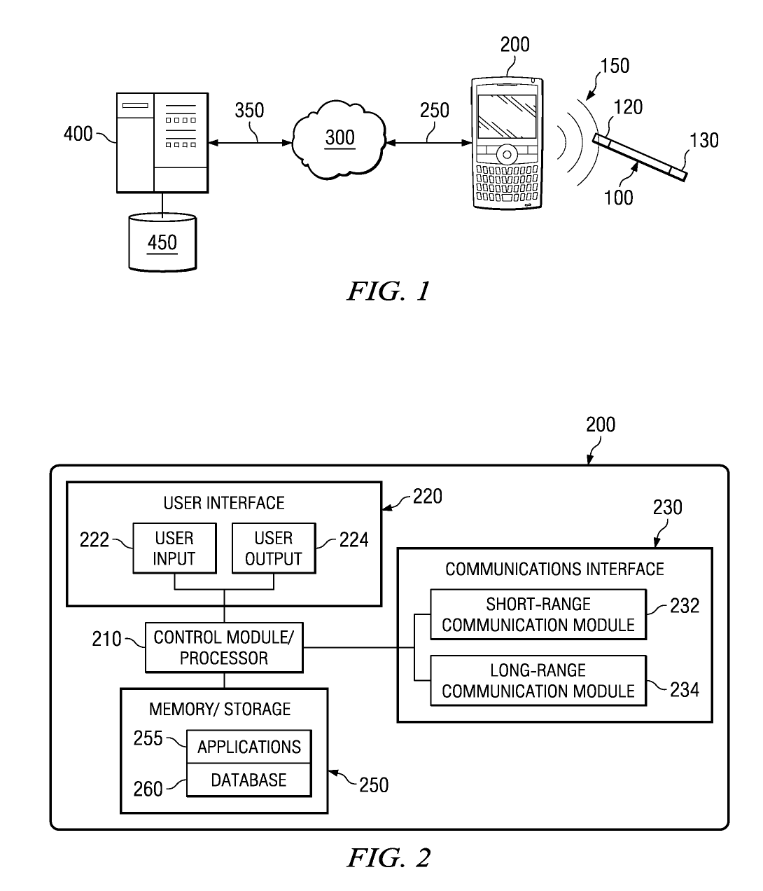

An example embodiment of the present invention and its potential advantages are understood by referring to FIGS. 1 through 6 of the drawings.

FIG. 1 discloses an example of operational environment in which an apparatus according to an example embodiment of the invention may be used. An apparatus 200, for example a a personal computer, an engineering workstation, a personal digital assistant, a portable computer, a computerized watch, a wired or wireless terminal, phone, node, and/or the like, a set-top box, a personal video recorder (PVR), an automatic teller machine (ATM), a game console, or the like is shown having a user interface, such as, for example a touch screen display. The apparatus, such as an electronic device, may be embodied in a portable wireless device having a wireless interface for communicating with network 300 via a wireless communication link 250 as illustrated in FIG. 1. According to an alternative example embodiment, the apparatus 200 may be a stationary device having a wireless and/or a wired interface for communicating with one or more networks.

As illustrated in FIG. 1, the apparatus 200 may be further associated with a pointing device 100 that may be operated to control the apparatus via a user interface. The pointing device may include one or more tips 120, 130 designed for providing indications to the tactile user interface when a user operates the pointing device 100 to interact with the apparatus 200. In the example embodiment shown in FIG. 1, there are two tips 120, 130 in the pointing device 100 that is embodied as a stylus for the apparatus 200. Either or both of the pointing tips 120, 130 may be further equipped with a short-range communication means, such as, for example a Radio-Frequency Identification (RFID) communication module and/or transponder, or a Bluetooth™ Low Energy communication module.

Radio-Frequency Identification (RFID) technologies provide wireless systems for automatic identification, tracking and managing of objects via a wireless connection between a tag attached to the object and a reader device. The tag may include a transponder that may be active or passive. In the presence of an electromagnetic field created by the reader device, the transponder may transmit at least an object identity signal. The reader device may sense and decode the broadcast signal to identify the object. The object identity is received by the reader device via a connectionless communication. In other words, the object identity signal is received without a logical connection between the reader device and the tag attached to the object. RFID technologies comprise a range of RF transmission systems, for example standardized and proprietary systems for a large number of different purposes, such as product tagging for inventory handling and logistics, theft prevention purposes at the point of sales and product recycling at the end of the life-cycle of the tagged product. In addition, RFID systems have been introduced for various payment and ticketing concepts comprising public transportation ticketing and payment. As an example, in several European countries and also in Canada and Mexico, there are several public transportation systems based on Calypso, the international electronic ticketing standard for microprocessor contactless smartcards, originally designed by a group of European transit operators. Further, for example in Japan, Hong Kong and Korea, there are Felicity Card (FeliCa) technology based mass transit systems, such as the Octopus card system in Hong Kong. The Octopus card is a rechargeable contactless stored value smart card used to transfer electronic payments in online or offline systems in Hong Kong.

In addition, RFID based tagging is a common technology for animal identification and similar concepts have been proposed to for human implantation also. An alternative wireless low power technology suitable for the purposes of at least one example embodiment of the present invention is Bluetooth™ low energy.

Bluetooth™ low energy is an extension for Bluetooth™ that is designed for low energy consumption. Bluetooth™ low energy may offer long-lasting connectivity with a low power consumption. Thus, Bluetooth™ low energy may extend the range of potential applications for Bluetooth™ communication. Bluetooth™ low energy is designed to bridge the gap between small sensor type devices and mobile devices as it consumes only a fraction of the power of a classic Bluetooth™ device. With Bluetooth™ low energy, a device may operate more than a year on a button cell battery without recharging.

According to an example embodiment, the pointing device 100 is equipped with an RFID transponder. Further, the apparatus 200 may be equipped with a means to scan the RFID transponder, for example an RFID reader, so that the apparatus 200 may read the information contained in the RFID transponder. This may be achieved by transmitting RFID interrogations 150 from the apparatus 200 and to receive a response at the apparatus 200 from the pointing device 100 when the RFID transponder of the pointing device 100 is positioned in a very close proximity. According to an example embodiment, the transmission range of the RFID reader of the apparatus 200 is 5 centimeters. According to a further example embodiment, the pointing device 100 is equipped with a Bluetooth™ Low Energy communication module and the apparatus 200 is equipped with a corresponding Bluetooth™ Low Energy communication module, wherein the Bluetooth™ Low Energy communication module of the pointing device 100 may periodically transmit advertisement messages including identification information so that the Bluetooth™ Low Energy communication module of the apparatus 200 may obtain the information when the pointing device 100 is in the vicinity of the apparatus 200. Both of the aforementioned example short-range technologies may be used in a pointing device 100 where size and power consumption requirements for the pointing device 100 are strict, for example in a stylus for the apparatus 200 and/or the like.

According to an example embodiment, the apparatus 200, is further equipped with a means to connect to a network 300 via a wireless communication connection 250. Depending on the embodiment, the wireless communication connection 250 may be provided over a short-range communication connection or a wide-are communication connection. Short-range communication connections may be used for the exchange of information over a local area varying for example from a couple of meters to some hundred of meters. Examples of wireless short-range communication technologies comprise Bluetooth™, WLAN, wireless universal serial bus (WUSB), ultra-wideband (UWB), ZigBee (802.15.4, 802.15.4a), and ultra high frequency radio-frequency identification (UHF RFID) technologies. Long-range communication connections may be used for the exchange of information over large geographic areas. Examples of wireless long-range communication technologies comprise 2^{nd} generation (2G) digital cellular networks, for example Global System for Mobile Communications (GSM) that may communicate in the 900 MHz/1.8 GHz bands in Europe and in the 850 MHz and 1.9 GHz bands in the United States. Long-range communication technologies may further comprise general packet radio service (GPRS) technology, universal mobile telecommunications system (UMTS) technology, code division multiple access (CDMA) technologies, and/or the like. Long-range communication technologies may also operate to transmit and receive text messages, such as via a short messaging service (SMS), and/or multimedia content via multimedia messaging service (MMS) messages. Long-range communication technologies may provide voice and data services. According to a further example embodiment, the connection 250 may be a wired connection, for example operating according to ethernet, IEEE 1394, universal serial bus (USB) protocol, any other serial or parallel wired connection, and/or the like.

Network 300 may be either a wireless network, or a wired network. Network 300 may further be connected to other networks. In an example embodiment, a server 400 including a database 450 may be connected to the network 300 via a connection 350. Database 450 may comprise and maintain association information between identification information and one or more data items. The identification information stored on the database 450 may correspond with the information received from the pointing device 100 at apparatus 200. According an example embodiment of the present invention, the apparatus 200 transmits the identification information via the network 300 to the server 400 in a service request upon receiving the identification information from the pointing device 100. Database 450 containing corresponding identification information may then be accessed and associated data items may be provided to the apparatus 200 in response to the request. So, the one or more data items containing information relating to the identification information stored on the database 450 may be accessible by apparatus 200 with the identification information contained on the pointing device 100.

According to another example embodiment, a database maintaining association between the identification information and the one or more data items may also be maintained within the apparatus 200. According to a further example embodiment, a database may also be maintained within the pointing device. According to a further example embodiment, database 450 may be divided and/or shared between two or more databases, for example database 450 on server 400, the database of apparatus 200, and/or the database of pointing device 100.

FIG. 2 discloses a modular layout for an apparatus according to an example embodiment of the present invention. The apparatus 200 is broken down into modules representing a number of functional aspects of the device. These functions may be performed by various combinations of the software and/or hardware components discussed below.

Control module 210 regulates operation of the apparatus 200. The control module may be embodied as a controlling means, for example as a controlling circuitry or a processor. Inputs may be received from various other modules comprised within apparatus 200. For example, user interface 220 may provide input to the control module 210 in response to receiving input from a user via user input 222. So, user input may be received via the user interface 220 may be used as an input in the control module 210 for controlling the operation of the apparatus 200. Control module 210 may interpret the data input and, in response, may issue one or more control commands to at least one of the other modules in apparatus 200.

In an example embodiment, apparatus 200, such as an electronic device, comprises a communications interface 230. Communications interface 230 may incorporate one or more communication modules of the apparatus 200. In an example embodiment, the communications module 230 may comprise a means for wired and/or wireless communication. As shown in the example of FIG. 2, communications interface 230 may comprise a short-range communications module 232 and a long-range communications module 234. The apparatus 200 may comprise further communications modules, for example further wired and/or wireless communication modules. Communications interface 230 may utilize one or more of these modules to receive communication from both local and long distance sources, and to transmit data to recipient devices from the apparatus 200. Communications interface 230 may be activated by control module 210, or by control resources local to the sub-modules responding to received messages, environmental influences and/or other devices in communication with the apparatus 200.

Short-range communication module 232 may comprise a near field communications interface configured to communicate over a short distance, for example over a range of a few centimeters. In an example embodiment, near field communication comprises radio-frequency identification (RFID) technologies including Near Field Communication (NFC) technology. As the RFID technologies are becoming more prevalent, there already exists a large amount of RFID based applications, for example transportation tickets, animal and/or human implantations for tracking and other purposes, and the like.

NFC is a RFID based technology that evolved from a combination of existing contactless identification and interconnection technologies operating at 13.56 MHz. NFC is a technology providing also bi-rectional directional communication between NFC devices. Communication between two NFC-compatible devices occurs when they are brought close to one another. NFC technology was introduced by a non-profit industry association named NFC Forum to advance the use of NFC short-range wireless interaction in consumer electronics, such as, for example, mobile devices and personal computers.

Short-range communication module 232 may also comprise short-range communication interface for exchanging information across short-range wireless network using a short-range communication protocol. Example communication protocols for short-range communication may comprise Bluetooth™, Bluetooth™ Low Energy (Bluetooth LE), wireless local area network (WLAN), ultra-wide band (UWB), and wireless universal serial bus (WUSB) technologies.

Long-range communication module 234 may comprise a long-range communications interface configured to communicate and exchange information over a long distance in a large geographic area using any of the wide-area communication technologies described earlier.

As a subset of long-range communications module 234, or alternatively operating as an independent module separately coupled to processor 210, the apparatus 200 may comprise a broadcast receiver. The broadcast receiver may be a digital audio- or video receiver, for example a digital audio broadcasting (DAB) or a digital video broadcasting (DVB) receiver, and/or the like. According to an example embodiment, the broadcast receiver comprises a Digital Video Broadcast for Handheld Apparatuses (DVB-H) receiver. The broadcasting transmissions may be encoded so that only certain apparatuses may access the transmitted content. The broadcast transmission may comprise text, audio and/or video information, and data. In an example embodiment, apparatus 200 may receive broadcasts and/or information within the broadcast signal to determine if the apparatus is permitted to view the received content.

According to an example embodiment, either of the short-range communications module 232, or long-range communications module 234 may be equipped with a wired interface that may be used for communicating with another device using a wired communication protocol via an interface such as ethernet, an IEEE 1394 communication interface, a universal serial bus (USB) interface, and/or the like.

User interface 220 may include visual, audible and/or tactile elements which allow a user to receive data from, and enter data into, the apparatus. Data entered by a user is received via user input module 222 and may be interpreted by control module 210, for example to affect the behavior of apparatus 200. User-inputted data may also be transmitted by communications interface 230 to another device. Information may also be received by other devices at the apparatus 200 via communications interface 230. Control module 210 may cause this information to be transferred to user interface 220 for presentation to the user via user output module 224. User interface 220 may comprise one or more user input and output modules, and there may also be a module operating both as a user input module 222 and user output module 224, for example a touch screen display operating as a tactile user interface.

Apparatus 200 may further comprise a memory or storage 250. Memory/storage 250 may be connected to controller 210. Memory/storage 250 may include an application module 250 which incorporates other hardware and/or software applications of apparatus 200. The memory/storage 250 may also incorporate a database 260. The database 260 may comprise one or more data items, for example information related to one or more users of the apparatus 200. The data items may be related to identification information. Memory/storage 250 may further store executable instructions that are configured to cause the apparatus 200 to perform various actions in co-operation with the control module 210.

In an example embodiment, when a user input module 222 of the user interface 220, for example a touch screen display or any other tactile user interface, detects that a currently displayed user interface element requiring user input is active, an indication is provided to the control module 210. In response, or in relation to the received indication, the control module 210 instructs the short-range communication module 232, for example a NFC communication module of the communications interface 230, to transmit a query for information identifying a user operating the apparatus 200. In another example embodiment, the short-range communication module may transmit the query in a periodic manner so that the user identification information may be received before or after the indication from the user input module or at the same time.

Using the user identification information, the control module 210 may then access the database 260 in the memory/storage 250 of the apparatus 200 to determine whether the database contains one or more data items corresponding to the received user identification information. If such one or more data items are available, the control module 210 may check whether any of the one or more data items comprises information suitable for inputting into the active user interface element. In case such information is available, the control module 210 may further cause the apparatus 200 to extract one or more information elements from the one or more suitable data items for inputting the required information into the active user interface element. In an example embodiment, the control module 210 may cause the user interface 220 to provide the extracted one or more information elements into the user interface element requiring user input.

If no data item or no suitable data item corresponding to the received user identification information is available in the database, the control module 210 may instruct the communications interface 230 to contact a remote server maintaining such information. The remote server may be, for example the server 400 shown on FIG. 1. Apparatus 200 may contact the server 400 to fetch information suitable for inputting to active user interface element(s) requiring user input. Upon receiving the information including one or more data items suitable for inputting to active user interface element(s) at apparatus 200, the one or more information elements may be extracted. The extracted one or more information elements may then be inputted on user interface 230 based on instructions provided by the control module 210.

With the above described automatic filling/inputting of user information into an active user interface element requiring user input, the user may continue operation of the apparatus 200 without needing to manually input the required information into the active user interface element. This type of operation may be advantageous in connection with touch screen interfaces.

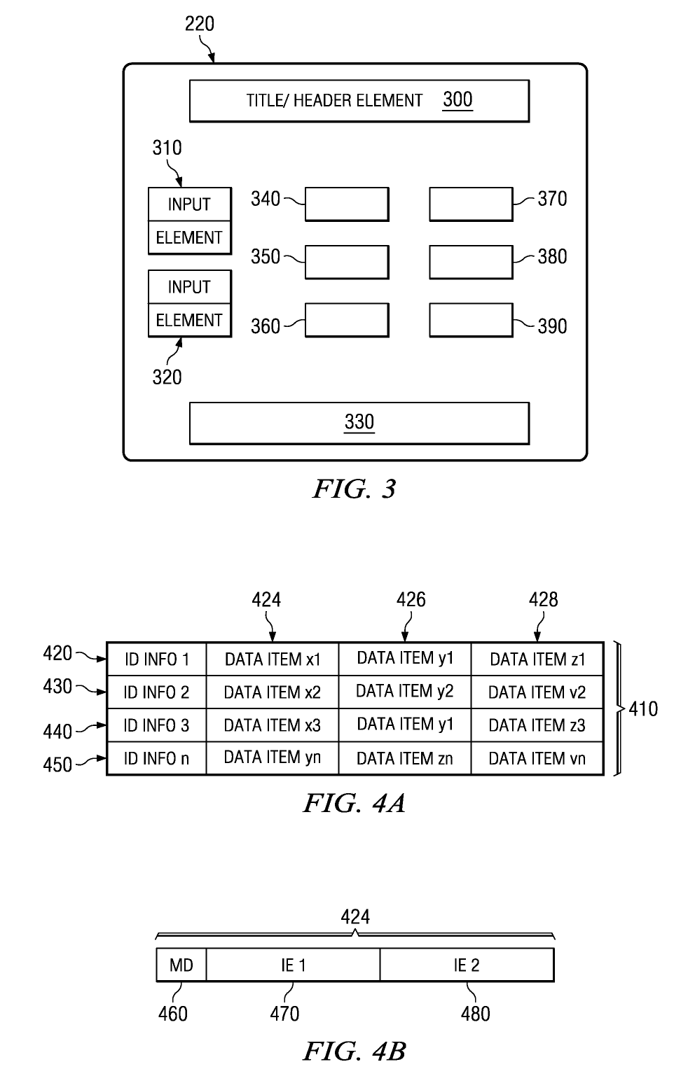

FIG. 3 discloses a user interface including several user interface elements according to an example embodiment of the present invention. The example user interface 220 of apparatus 200 may comprise one more user interface elements, such as, user interface elements 300-390 shown on FIG. 3. According to this example embodiment, user interface element 300 may be considered as an element containing title or header information indicative of the contents of a currently available user interface view. The user interface view may be provided by an application, for example an Internet browser accessing an Internet site providing a service. Also, other types of user interface elements 310 and 320 may be shown containing information request fields querying information from a user, for example for registering to a service identified by user interface element 300, for signing in as a registered user of an identified service, and/or the like. So, in other words, the user interface elements 310 and 320 require user input. If a user activates at least one of the user interface elements 310 and 320, then (s)he needs to input the required information in the actived user interface element. Examples of such type of information may comprise a username and a password for a service, for example a banking service, an email account, and/or the like.

In an example embodiment, a user may activate either of the user interface elements 310, 320 requiring user input for example with a pointing device 100 containing identification information. After receiving the identification information, the apparatus 200 may access one or more data items corresponding to the identification information. The identification information may be any kind of information that may be considered as information identifying a user of the apparatus 200. The example user interface view shown in FIG. 3 may also comprise other user interface elements 330-390 that may comprise one or more informative user interface elements similar to user interface element 300. User interface elements 330-390 may also comprise one or more user interface elements requiring user input in addition to user interface elements 310 and 320.

FIG. 4A discloses contents of a database 410 according to at an example embodiment of the present invention. Example database 410 may reside in a remote server as shown in FIG. 1 with server 400 and database 450. Further, the example database 410 may reside within the apparatus 200 of FIG. 2, for example as database 260 in memory 250 of the apparatus 200.

Example database 410 comprises identification information fields 420, 430, 440 and 450 containing identification information that corresponds to user identification. Specific data items may be explicitly identified with corresponding identification information. When for example the apparatus 200 of FIG. 1 receives identification information from pointing device 100, the identification information may be matched against various identification information fields 420, 430, 440 and 450. If a matching identification information field is found in the database 410, data items associated with the matching identification information field may be accessed. As shown on FIG. 4A, each of the identification information fields 420, 430, 440 and 450 may be associated with one or more data items. For example identification information 420 may be associated with data items, 424, 426 and 428. The various data items associated with certain identification information may relate to different context/user interface elements requiring user input. For example, data item 424 may be related to a user identification in connection with a network game server and may comprise information for logging in the user to the service. Data item 426 may be related to more general information that may be suitable for registering the user for the game server. Data item 428 may comprise necessary user input information for allowing a user to log in to an email account provided by an email service provider.

FIG. 4B illustrates example contents of a specific data item within the example database 410 according to at least one embodiment of the present invention. The example data item is shown as the data item 424 of FIG. 4A that may relate to user identification in connection with a network game server. Data item 424 may comprise information for logging in the user to the service according to the example above. As shown in FIG. 4B, the data item 424 may comprise one or more information elements, for example metadata, context information element 460, and/or one or more information elements 470 and 480. The metadata and/or context information element 460 contains the necessary information for matching the data item 424 to a suitable context. So, according to the example where the data item 424 relates to the network gaming server, the context and/or context information may comprise an address of a service providing server, for example “www.acme-games.com”. The data item may further comprise some more specific information identifying the context of the information within the server, for example “log-in”. The information elements 470 and 480 may comprise the actual input information that is extracted from the data item 424 in case the metadata and/or context information element 460 matches with the context of the active user interface element, for example user interface element 310 shown of FIG. 3. According to this example embodiment, the information element 470 may comprise a user name of the user for the network game server, and an information element 480 may comprise a password of the user for the network game server. The user name and the password may be needed for logging the user in to the network gaming service provided be the network game server.

Similarly, as indicated in the example above, data item 428 of FIG. 4A may relate to user identification of the same user in connection with an e-mail account providing a service, wherein the data item 428 may comprise one or more information elements for entering user log-in information to an account at a server of an email service provider, for example “https://mail.ovi.com” for accessing the user's e-mail account.

According to another example, data item 428 of FIG. 4A may relate to user identification of a user in connection with a banking service, wherein the data item 428 may comprise one or information elements for entering user log-in information for accessing the user's bank account in a banking service website, for example “www.acmegroup-banking com”. Further, the banking account information may be considered sensitive information that should not be accessible automatically by simply touching the active user interface element with suitable pointing device. Therefore, the banking service website may require an additional token identification, which may be manually inputted by the user in connection with logging in to the banking service.

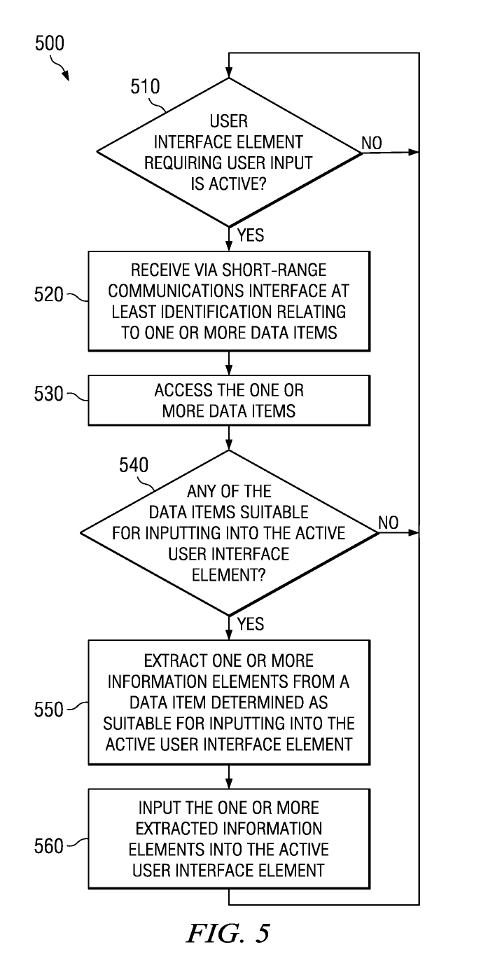

FIG. 5 illustrates a method 500 for user interaction according to an example embodiment of the present invention. Initially at block 510, a determination is made whether a user interface element requiring user input is active. The determination may be based on a detection of an activation of a user interface element requiring user input via a tactile user interface, for example detection of an activation of the user interface element 310 of FIG. 3. Returning to FIG. 5, if the determination indicates that no user interface element requiring user interaction is active, the loop goes back to the decision block 510 until it is detected that a user interface element requiring user input is active.

When it is detected that a user interface element requiring user input is active, the method continues at block 520. At block 520, at least an identification information relating to one or more data items is received via a short-range communications interface, for example via an RFID/NFC interface. With the received identification information, the one or more data items may be accessed at block 530. In an example embodiment, the data items may be accessed by way of accessing a memory associated with the device, for example memory 250 of apparatus 200 in FIG. 2. According to an alternative embodiment, the data items may be accessed by way of communicating with a proximate device, such as, for example the pointing device 100 of FIG. 1 via a short-range communication interface. According to a yet further example embodiment, the data items may be accessed by way of connecting to a remote network resource, for example database 450 on server 400 of FIG. 1.

Returning to FIG. 5, after the one or more data items are accessed, a determination is made at block 540 whether any of the accessed data items is suitable for inputting into the active user interface element. The determination may comprise further determining a context of the active user interface element requiring user input and checking whether any of the one or more accessed data items corresponds with the determined context. In case none of the accessed data items is suitable for inputting into the active user interface element, the method goes back to decision block 510. In case the decision block 540 indicates that a suitable data item for inputting into the active user interface element has been accessed, the method continues at block 550. At block 550, one or more information elements are extracted from the data item for inputting the required information into the active user interface element in block 560. At block 560, the one or more extracted information element is inputted into the active user interface element.

In an example embodiment, the actual input of a data item to the active user interface element is performed only after receiving a further indication via the tactile user interface. This embodiment may ensure that the user input information is not immediately inputted to the active user interface element requiring user input as the user may have activated the user interface element by accident. So instead of automatically logging a user into a service, the user needs to confirm a further indication in order to log into the service. The further indication may comprise another touching of the active user interface element, confirming a message box, and/or any other way of providing a further indication to a user interface.

Without in any way limiting the scope, interpretation, or application of the claims appearing below, a technical effect of one or more of the example embodiments disclosed herein may be automatic inputting of user information into an active user interface element requiring user input, wherein a user of the device does not need provide the actual user information entries. So, in other words, suitable user information is inputted to an appropriate user interface element in response to an activation of the user interface element without requiring the user to manually input suitable user information.

Various operations and/or the like described herein may be executed by and/or with the help of computers. Further, for example, devices described herein may be and/or may incorporate computers. The phrases “computer”, “general purpose computer”, and the like, as used herein, refer but are not limited to a media device, a personal computer, an engineering workstation, a personal digital assistant, a portable computer, a computerized watch, a wired or wireless terminal, phone, node, and/or the like, a set-top box, a personal video recorder (PVR), an automatic teller machine (ATM), a game console, and/or the like.

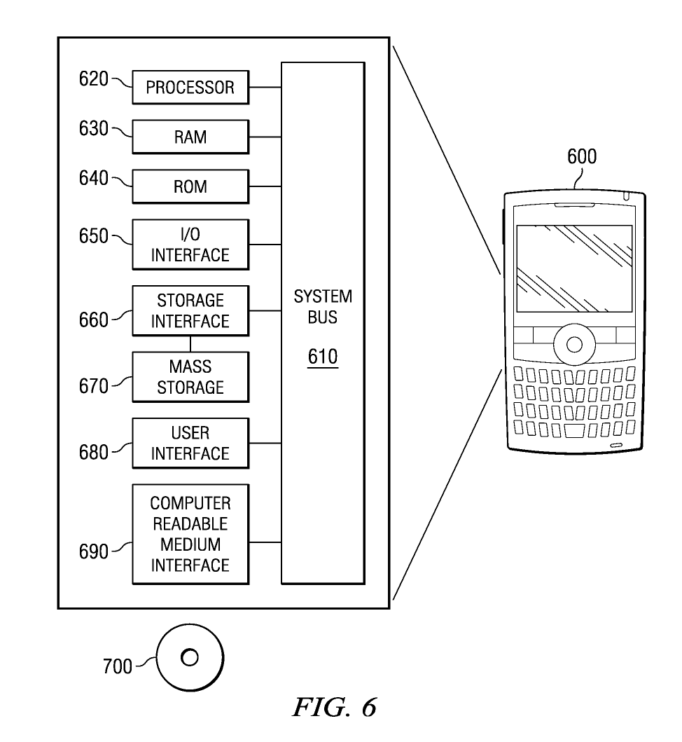

Embodiments of the present invention may be implemented in software, hardware, application logic or a combination of software, hardware and application logic. The software, application logic and/or hardware may reside on a memory of apparatus 200. In an example embodiment, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 6. A computer-readable medium may comprise a computer-readable storage medium that may be any media or means that may contain or store the instructions for use by or in connection with an instruction execution system, apparatus, or device, such as a computer.

The phrases “general purpose computer”, “computer”, and the like may also refer to one or more processors operatively connected to one or more memory or storage units, wherein the memory or storage may contain data, algorithms, and/or program code, and the processor or processors may execute the program code and/or manipulate the program code, data, and/or algorithms. Accordingly, example computer 600 as shown in FIG. 6 that may be considered as one embodiment of the apparatus 200 illustrated on FIG. 2 may include various hardware modules for causing the computer to implement one or more embodiments of the present invention. According to one example, the computer 600 include a system bus 610 which may operatively connect processor 620, random access memory 630, read-only memory 640 that may store for example a computer code for the computer 600 to perform the example method illustrated on FIG. 5. The system bus 610 may further operatively connect input output (I/O) interface 650, storage interface 660, user interface 680 and computer readable medium interface 690. Storage interface 660 may in turn connect to mass storage 670.

Mass storage 675 may be a hard drive, optical drive, or the like. Processor 620 630 may comprise a microcontroller unit (MCU), a digital signal processor (DSP), or any other kind of processor. Computer 600 as shown in this example also comprises a touch screen and keys operating in connection with the user interface 680. In various example embodiments, a mouse, and/or a keypad may alternately or additionally be employed. Computer 600 may additionally include the computer readable medium interface 680, that may be embodied by a card reader, a DVD drive, a floppy disk drive, and/or the like. Thus, media containing program code, for example for performing method 500 of FIG. 5, may be inserted for the purpose of loading the code onto the computer.

Computer 600 may run one or more software modules designed to perform one or more of the above-described operations. Corresponding program code may be stored on a physical media 700 such as, for example, DVD, CD-ROM, and/or floppy disk. It is noted that any described division of operations among particular software modules is for purposes of illustration, and that alternate divisions of operation may be employed. Accordingly, any operations discussed as being performed by a software module may instead be performed by a plurality of software modules. Similarly, any operations discussed as being performed by a plurality of modules may instead be performed by a single module. It is noted that operations disclosed as being performed by a particular computer may instead be performed by a plurality of computers.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method comprising:
detecting via a user interface that a user interface element requiring user input is active;
receiving via a short-range communications interface at least identification information relating to one or more data items;
accessing the one or more data items; and
determining whether any of the one or more data items is suitable for inputting into the active user interface element.

2. (canceled)

3. (canceled)

4. (canceled)

5. (canceled)

6. A method according to claim 1, wherein the active user interface element requiring user input is displayed on a touch screen display.

7. A method according to claim 1, wherein the determining whether any of the one or more data items is suitable for inputting into the active user interface element comprises:
determining a context of the active user interface element requiring user input; and
checking whether any of the one or more accessed data items corresponds to the determined context.

8. A method according to claim 1, further comprising extracting one or more information elements from a data item suitable for inputting into the active user interface element.

9. A method according to claim 8, further comprising inputting the one or more extracted information elements into the active user interface element requiring user input.

10. A method according to claim 8, wherein the one or more extracted information elements are inputted into the active user interface element requiring user input in response to receiving a further indication.

11. A method according to claim 10, wherein the further indication is received via at least one of the user interface and the short-range communications interface.

12. (canceled)

13. A method according to claim 1, wherein when none of the accessed data items is suitable for inputting into the active user interface element, a query comprising the received identification information is transmitted over a wide area communications link.

14. A computer program product comprising computer executable program code recorded on a non-transitory computer readable storage medium, the computer executable program code comprising:
code configured to detect via a user interface that a user interface element requiring user input is active;
code configured to receive via a short-range communications interface at least identification information relating to one or more data items;
code configured to access the one or more data items; and
code configured to determine whether any of the one or more data items is suitable for inputting into the active user interface element.

15. The computer program product according to claim 14, wherein the configured to determine whether any of the one or more data items is suitable for inputting into the active user interface element comprises:
code configured to determine a context of the active user interface element requiring user input; and
code configured to check whether any of the one or more accessed data items corresponds to the determined context.

16. The computer program product according to claim 14, further comprising code configured to extract one or more information elements from a data item suitable for inputting into the active user interface element.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. An apparatus, comprising:
a user interface configured to indicate activation of a user interface element requiring user input;
a short-range communications interface configured to receive at least identification information relating to one or more data items; and
a processor, configured to:
access the one or more data items; and
determine whether any of the one or more data items is suitable for inputting into the active user interface element.

32. (canceled)

33. (canceled)

34. (canceled)

35. (canceled)

36. An apparatus according to claim 31, wherein the active user interface element requiring user input is displayed on a touch screen display.

37. An apparatus according to claim 31, wherein the processor is further configured to:
determine a context of the active user interface element requiring user input; and
check whether any of the one or more accessed data items corresponds to the determined context.

38. An apparatus according to claim 31, wherein the processor is further configured to extract one or more information elements from a data item determined as suitable for inputting into the active user interface element.

39. An apparatus according to claim 38, wherein the processor is further configured to input the one or more extracted information elements into the active user interface element requiring user input.

40. An apparatus according to claim 38, wherein the processor is further configured to input the one or more extracted information elements into the active user interface element requiring user input in response to receiving a further indication.

41. An apparatus according to claim 40, wherein the further indication is received via at least one of the user interface and the short-range communications interface.

42. (canceled)

43. An apparatus according to claim 31, wherein the processor is further configured to initiate transmission of a query comprising the received identification information over a wide area communications link when none of the accessed data items is suitable for inputting into the active user interface element.

44. An apparatus according to claim 31, wherein the processor is further configured to run a software application providing the active user interface element requiring user input on the user interface.
